(19) United States
(12) Patent Application Publication
(10) Pub. No.: US 2007/0050975 A1
(43) Pub. Date: Mar. 8, 2007

(54) Blowing of optical fiber cables into ducts

(76) Inventors: George Henry Platt Brown, Galshiels (GB); David John Stockton, Suffolk (GB)

Correspondence Address: Jack Schwartz & Associates, 1350 Broadway, Suite 1510, New York, NY, 10018, US

(21) Appl. No.: 10/543,965

(22) PCT Filed: Feb. 16, 2004
(86) PCT No.: PCT/GB04/00580

§ 371 Date: May 2, 2006

(30) Foreign Application Priority Data
Feb. 20, 2003 (GB) 0303879.1

(51) Int. Cl. H01R 43/00

(52) U.S. Cl. 29/868; 29/870

(57) ABSTRACT

A method of installing a plurality of cables into a network (30) of ducts is disclosed. The method includes blowing a plurality of cables (34) through a first duct (31) such that a first portion (35) of each of tilt; cables (34) occupies the first duct (31). The plurality of cables (34) are also blown into a plurality of second ducts (32) such that each second duct (32) is occupied by a second portion (37) of at feast one of the plurality of cables (34).

The present invention relates to a method of installing cables in to a network of ducts, and relates particularly, but not exclusively, to a method of installing optical fibre cables.

FIG. 1 shows a prior art fibre optic cable 10 in which cable elements 11, each of which contains 12 optical fibres, are packaged in a robust construction, comprising a central strength member 15, some spacers 14 and an outer protective sheath 13. The cables 10 are usually installed in a duct (not shown) by (i) initially installing a rope into the duct and pulling the cable 10 into the duct by means of the rope, or (ii) blowing the cable into the duct by means of compressed air. Such cables and installation processes are well known to those skilled in the art.

Cables of the type shown in FIG. 1 are typically 6 mm in diameter and are installed in tubes with an outside diameter of 10 mm. They work well in networks in which all of the fibres in a single bundle are required by the same user and the fibres are required to start and terminate at a single location. However, it is increasingly necessary to direct fibres from a single location to a number of users. In the case of the cable 10 shown in FIG. 1, this is achieved by laying the cable containing 48-fibres and constructed using four sub-assemblies, each containing 12 optical fibres, in a duct network. At various points along the route of the cable, the sheath 13 of the cable is opened to expose the individual 12-fibre sub-assemblies 11, one of which is then cut. The fibres of the cut sub-assembly are then fusion spliced to those of a smaller, 12-fibre cable, which is installed in a separate duct extending to a user.

This arrangement suffers from the disadvantage that cutting and splicing optical fibres is highly disadvantageous, since splicing is time consuming and expensive, requiring a high level of skill on the part of the person carrying out splicing, as well as costly splicing machinery and expensive enclosures to protect the completed splice. Each splice in an optical fibre also causes signal losses and is a potential point of failure.

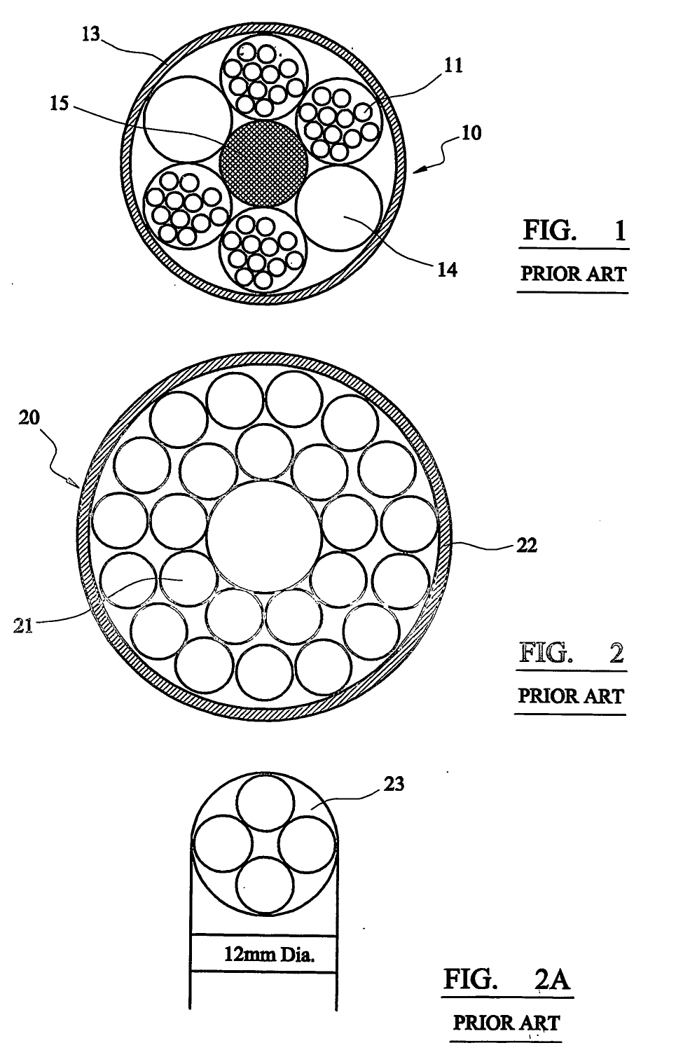

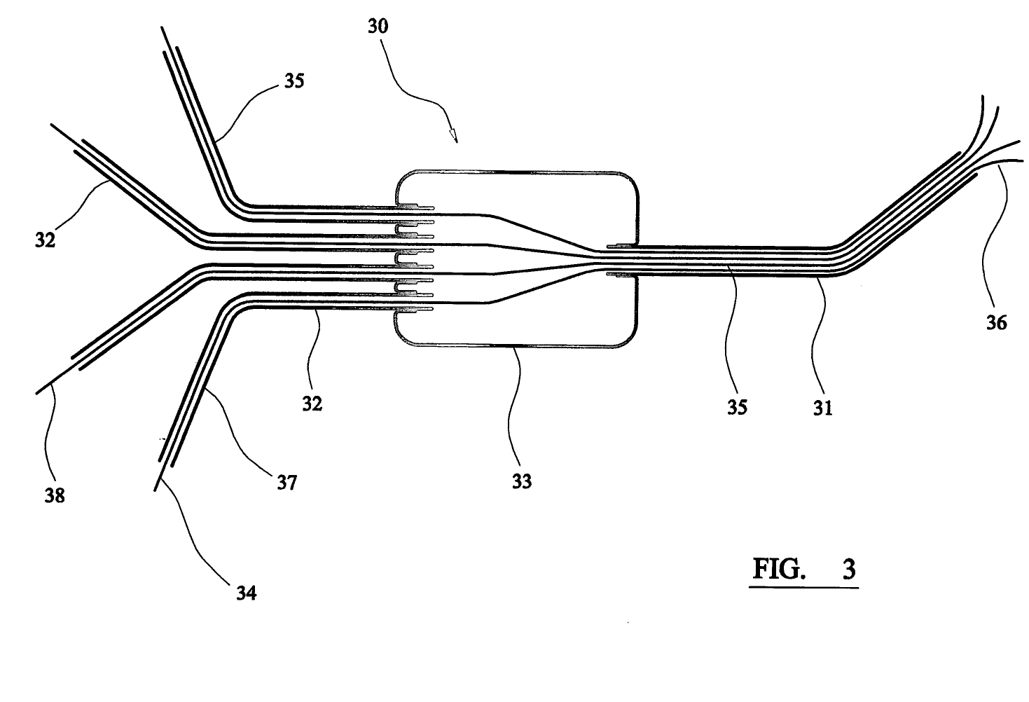

An attempt to overcome this problem is shown in FIG. 2, which shows a cable 20 containing up to 24 small-bore empty tubes 21. The cable 20, initially not containing any optical fibres, is installed in the ground and at appropriate points the sheath of the cable is removed, one of the miniature tubes cut, and a separate tube connected to it. In this way, a network of empty tubes starts at a central location and terminates at several locations. A miniature fibre optic cable for example as described in EP 0521710 and usually comprising up to 12 individual fibres is then installed in each of the tubes by blowing.

Although this prior art arrangement is highly advantageous in that splicing of optical fibres is avoided, it suffers from the drawback that the number of optical fibres which can be deployed in a given cross-sectional area is less than for conventional cables, because of the space each miniature cable needs to be surrounded by to enable the blowing process to occur. FIG. 2A shows a bundle of four tubes each with outside diameter of 5 mm and internal diameter of 3.5 mm. Each tube is suitable for the installation of one miniature fibre, optic cable containing up to 12 fibres. The outside diameter of the four tubes in FIG. 2A is 12 mm, 2 mm bigger than the size of tube required for the installation of the 48 fibres of the cable in FIG. 1. This is highly disadvantageous where optical fibre cables are to be installed in existing duct networks where space is limited, for example in telecommunication networks, particularly in such networks in cities.

WO00/19258 discloses a method of installing an optical fibre cable into a duct comprising first and second lengths of duct. The optical fibre cable is located adjacent an access location between the first and second lengths of duct, and a first end of the cable is blown into the first length of duct and a second end of the cable is blown into a second end of the duct. However, this method has to date only been used to install a single optical fibre cable into a single duct comprising first and second lengths, and it has not previously been considered possible to install more than one cable in a single length of duct by means of this method.

Preferred embodiments of the present invention seek to overcome the above disadvantage of the prior art.

According to the present invention there is provided a method of installing a plurality of cables into a network of ducts, the method comprising:

blowing, from a first location, a plurality of cables into a first duct such that a first portion of each of said cables occupies said first duct; and

blowing, from said first location, said plurality of cables into a plurality of second ducts such that each said second duct is occupied by a second portion of at least one of said plurality of cables.

By blowing a plurality of cables into a first duct, this provides the advantage of significantly increasing the number of cables which can be installed in a given cross-sectional area. It is possible to install four miniature fibre optic cables each containing up to 12 fibres in a tube with an outside diameter of 8 mm compared with 10 mm and 12 mm of the prior art.

Said first location may be between said first and second ducts.

This provides the advantage of reducing the cost of installation.

The method may further comprise the step of forming an aperture in a said first duct, and mounting a said second duct to said first duct, subsequently to blowing of at least one said cable into said first and second ducts, to form a junction between said first and second ducts through which at least one said cable passes.

The method may further comprise the step of sealing said aperture.

This provides the advantage of enabling sufficient pressure to be developed in the first duct to permit blowing of subsequent cables into said first duct.

Preferably, a plurality of said cables are blown into said first duct substantially simultaneously.

This provides the advantage of significantly reducing installation time and therefore also reduces the cost of installation, as well improving the reliability of the installation process, since installation of a cable in the same duct as an existing cable can be difficult.

The coefficient of friction of at least one said cable with a said duct may be within 20% of the coefficient of friction of said cable with a further said cable.

This provides the advantage of minimising the risk of unpredictable behaviour of a cable being installed into a duct which already contains one or more cables.

Preferably, the surface of at least one said cable and/or said first duct and/or a second duct is modified to reduce friction.

Conveniently, the surface of at least one said cable and/or said first duct and/or said second duct includes a mixture of one or more polymers and one or more friction reducing materials.

Preferably, the polymer is polyethylene.

At least one said friction reducing material may include at least one slip agent.

The method may further comprise the step of sealing at least one said duct.

The step of sealing the or each said duct may be achieved by means of at least one deformable material.

At least one said deformable material may be rubber.

Preferred embodiments of the present invention will now be described, by way of example only and not in any limitative sense, with reference to the following drawings in which:

FIG. 1 shows a prior art fibre optic cable;

FIG. 2 shows a prior art arrangement in which an arrangement of tubes for carrying fibres is disposed in a duct;

FIG. 3 shows a network of ducts and associated cables installed by means of a method embodying the present invention;

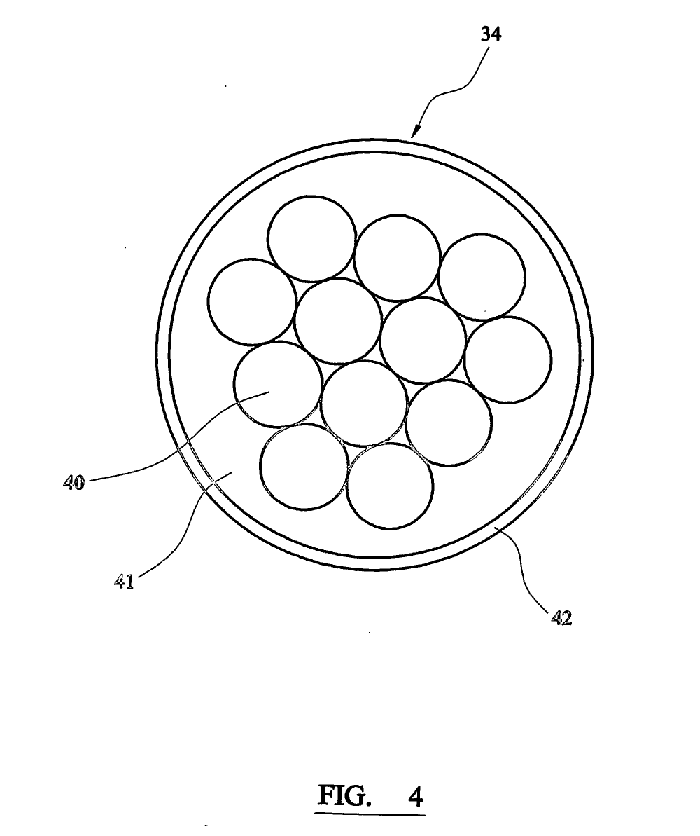

FIG. 4 is a cross-sectional view of a fibre optic cable for installation by means of a method embodying the present invention;

FIG. 5 shows a duct network having branch ducts formed by a method embodying the present invention; and

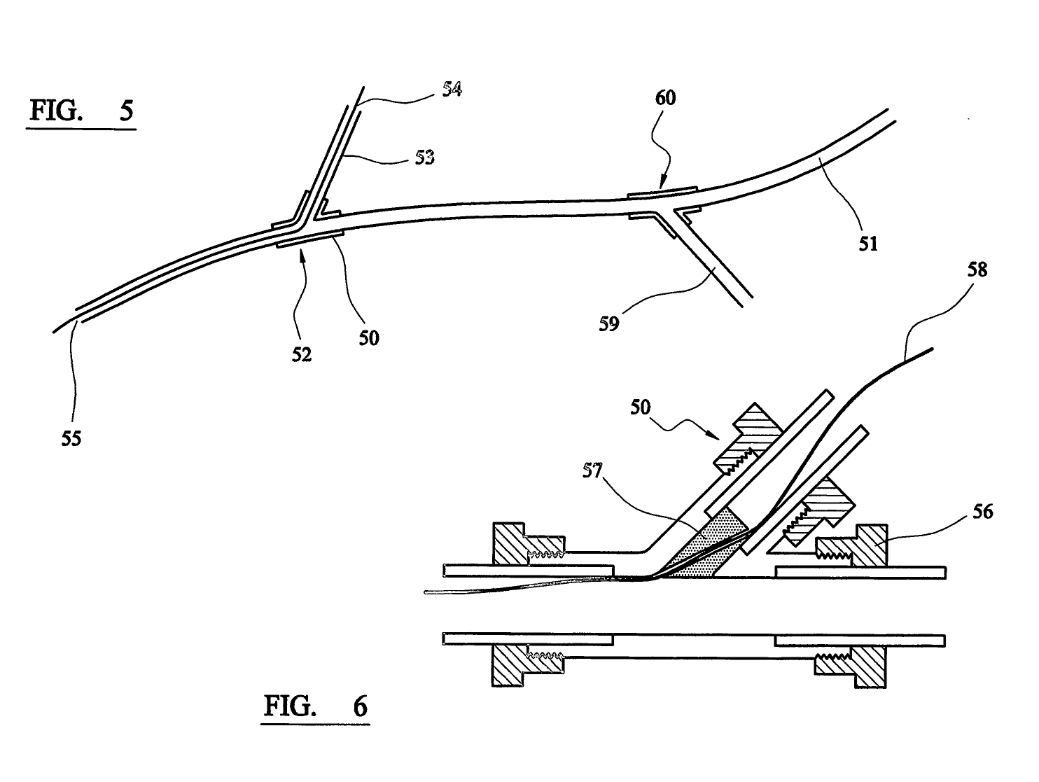

FIG. 6 is a cross-sectional view of a junction piece of FIG. 5.

Referring to FIG. 3, a duct network 30 for use in a method embodying the present invention includes a single first duct 31 and a series of second ducts 32, the first 31 and second 32 ducts being connected to each other by means of a suitable accessible location such as a manhole containing a suitable waterproof enclosure 33 familiar to those skilled in the art. Such waterproof enclosures can be obtained from Tyco Electronics Raychem N.V Belgium. A series of optical fibre cables 34 is installed in the network 30, a plurality of the cables 34 being blown simultaneously into the first duct 31 such that a first portion 35 of each of the cables 34 occupies the first duct, and the opposite end of one or more of the cables 34 being blown into the second duct 32 such that a second portion 37 of at least one cable 34 is contained within each second duct 32. The first ends 36 of the cables 34 extending through first duct 31 are connected to a central location such as a telecommunications exchange, and second ends 38 of the cables 34 extending from second ducts 32 are connected to individual users or groups of users.

By providing an arrangement in which a single first duct 31 is occupied by a first portion of a plurality of cables 34, this provides the significant advantage over the prior art that a much larger number of optical fibres can be installed in a given cross sectional area of the first duct 31, while avoiding the necessity of splicing individual optical fibres.

Referring to FIG. 4, each of the cables 34 contains a core consisting of 12 primary coated optical fibres 40, embedded in an inner layer 41 of acrylate material. The inner layer 41 is then surrounded by a loose thin jacket 42 formed from a mixture of polyethylene and a generally uniformly distributed slip agent such as a dimethylsiloxane material. The ducts 31, 32 are generally made of low friction material such as polyethylene. The internal surfaces of the ducts 31, 32 and the external surfaces of the cables 34 are modified by the addition of a slip agent such that the coefficient of friction of each cable 34 with the internal surface of the ducts 31, 32 generally the same as the coefficient of friction of the cables 34 with each other. This reduces unpredictable installation performance when a cable 34 is installed into the first duct 31 when a cable 34 is already located within the duct 31. The external surface of the cable 34 is preferably smooth but may also be provided with longitudinal ribs (not shown), which avoid locking of the cables to each other as the cables are installed sequentially one on top of the other.

An alternative method of deployment of the miniature optical fibre cable is shown in FIGS. 5 and 6. A first duct in the form of a single tube 51 is laid from an exchange building or an optical node, to an area where individual end users or groups of end users need to be connected using one or more of the miniature optical fibre cables. The tube is cut at a location 52 which is adjacent to a user or group of users to be connected. A new section 53 of tube is installed from the cut location 52 to the user 54. A miniature fibre optic cable is blown from 52 to the user 54 and to the exchange or optical node 55. The new section of tube 53 and the original tube 51 are then connected using a suitable Y branch 50, which is shown in more detail in FIG. 6. The Y branch 50 comprises two halves which can be clamped together using threaded nuts 56 and can be made water and air tight with suitable rubber seals (not shown). The point at which the miniature fibre optic cable exits the tube 51 is sealed using a split rubber bung which has a suitable sized hole to accommodate the miniature fibre optic cable 58. The rubber bung 57 is compressed when the nuts 56 are tightened effectively sealing the tube 51 at the cut point 52.

This process of sealing the cut point is important so that when a new user 59 is to be connected and the tube 51 is cut at cut point 60 then it is possible to blow a miniature fibre optic cable down the tube 51 to the exchange or optical node 55. If the tube 51 were not sealed at 52 by bung 57 then air used to blow the miniature fibre optic cable would leak from the tube 51 resulting in poor blowing performance.

When miniature fibre optic cables are installed using this second method then it is important that the friction characteristics of the sheath of the cable and the inside of the tube are comparable, otherwise the installation performance will become very unpredictable as one such cable is installed on top of another cable.

It will be appreciated by persons skilled in the art that the above embodiment has been described by way of example only, and not in any limitative sense, and that various alterations and modifications are possible without departure from the scope of the invention as defined by the appended claims. For example, the method may be used to install electrical cables, in addition to fibre optic cables, and the cables 34 may be installed in each duct 31, 32 from the end thereof remote from the manhole 33. In addition, more than one cable 34 may be installed in each of the second ducts 32. It is also possible to blow cables into the individual second ducts 32 first and then blow several cables into the single first duct 31 second.

1. A method of installing a plurality of cables into a network of ducts, the method comprising:
blowing, from a first location, first ends of a plurality of cables into a first duct such that a first portion of each of said cables occupies said first duct; and
blowing, from said first location, second ends of said plurality of cables into a plurality of second ducts such that each said second duct is occupied by a second portion of at least one of said plurality of cables.

2. A method according to claim 1, wherein said first location is between said first and second ducts.

3. A method according to claim 2, further comprising the step of forming an aperture in a said first duct, and mounting a said second duct to said first duct, subsequently to blowing of at least one said cable into said first and second ducts, to form a junction between said first and second ducts through which at least one said cable passes.

4. A method according to claim 3, further comprising the step of sealing said aperture.

5. A method according to claim 1, wherein a plurality of said cables are blown into said first duct substantially simultaneously.

6. A method according to claim 1, wherein the coefficient of friction of at least one said cable with a said duct is within 20% of the coefficient of friction of said cable with a further said cable.

7. A method according to claim 1, wherein the surface of at least one said cable and/or said first duct and/or a second duct is modified to reduce friction.

8. A method according to claim 7, wherein the surface of at least one said cable and/or said first duct and/or said second duct includes a mixture of one or more polymers and one or more friction reducing materials.

9. A method according to claim 8, wherein the polymer is polyethylene.

10. A method according to claim 8, wherein at least one said friction reducing material includes at least one slip agent.

11. A method according to claim 1, further comprising the step of sealing at least one said duct.

12. A method according to claim 11, wherein the step of sealing said duct is achieved by means of at least one deformable material.

13. A method according to claim 12, wherein at least one said deformable material is rubber.
